(19) United States
(12) Patent Application Publication
(10) Pub. No.: US 2007/0029379 A1
(43) Pub. Date: Feb. 8, 2007

(54) Method of automated generation of access controlled, personalized data and/or programs

(75) Inventor: Marco Peyer, Horgen (CH)

Correspondence Address: OLIFF & BERRIDGE, PLC, P.O. BOX 19928, ALEXANDRIA, VA, 22320, US

(73) Assignee: SWISS REINSURANCE COMPANY, ZURICH (CH)

(21) Appl. No.: 10/568,581

(22) PCT Filed: Aug. 26, 2003
(86) PCT No.: PCT/CH03/00579

§ 371 Date: May 12, 2006

(51) Int. Cl. G06K 5/00

(52) U.S. Cl. 235/382

(57) ABSTRACT

System and method of automated generation of access-controlled, personalized data and/or programs, a user (10, . . . , 14) accessing a central unit (40) via a network (30/31) by means of a communication device (20, . . . ,24) and the access-controlled data and/or programs being transmitted to the communication device (10, . . . , 14), logical records (421, . . . ,423) being generated having data elements (4211, . . . ,4214) divided according to authorization classes and the personalized, access-controlled data and/or programs being generated by means of a filter module (41) of the central unit (40) based on the authorization class of the user (10, . . . , 14) and on the access request data of the user (10, . . . , 14).

The invention relates to a system and a method for automated generation of access-controlled, personalized data and/or programs with which a user accesses a central unit via a network by means of a communication device, and the access-controlled data and/or programs are transmitted to at least one communication device.

Worldwide at the present time more and more computer and communication systems are being used to obtain or to transmit personalized data over networks, such as e.g. a LAN (Local Area Network), a WAN (Wide Area Network) or the Internet via e.g. the public switched telephone network (PSTN) or a mobile radio network (PLMN: Public Land Mobile Network) such as, for instance, GSM (Global System for Mobile Communication) or UMTS networks (Universal Mobile Telephone System) etc. In particular personalized data are thereby presented and/or processed and/or made available modified to other computer systems. Coming under such personalized data are, among other things, digital data such as texts, graphics, pictures, animations, video, QuickTime and sound recordings. Also belonging thereto are MPx (MP3) or MPEGx (MPEG7) standards, as they are defined by the Moving Picture Experts Group, or executables, such as programs and applets. In generating and transmitting personalized data today not only is the growing quantity of data (e.g. with multimedia data) a problem to be solved in most cases, but so is the securing of the data, the supply or making available of the data, the administration and the billing of the data. These data are to be generated for a specific user in a personalized way according to his access rights, creditworthiness, etc. Contributing to the great demand for sensible technical solutions to these problems in recent years have been the fast growing popularity of services such as the Internet, the demand for multimedia data “on demand”, such as e.g. video films or programs/data and network-capable multi-user applications and moreover in particular professional services for firms and their employees among themselves. The international patent publication WO 98/43177 of the state of the art shows an example of such a system which dynamically selects, extracts and user-specifically adapts data from databases, this data being transmitted to the user of the system. However, this solution has the drawback, among others, that the access to same logical records cannot be controlled according to different users, or only with difficulty. Thus information cannot be user-specifically handled e.g. already before filtering, which does not allow for any technically sensible solution, in particular with respect to data security, etc.

It is an object of this invention to propose a new system and method for automated generation of access-controlled, personalized data and/or programs which do not have the above-mentioned drawbacks of the state of the art. In particular, a simple and rational automated system and method should be proposed for generating data simply and user-specifically (personalized data), administering said data and putting it at the disposal of the respective user.

This object is achieved according to the present invention in particular through the elements of the independent claims. Further preferred embodiments follow moreover from the dependent claims and from the specification.

In particular these objects are achieved through the invention in that a user accesses a central unit via a network by means of a communication device, and access-controlled data and/or programs are transmitted to at least one communication device, logical records being generated with data elements divided according to authorization classes and being stored in at least one source database, the user being identified by the central unit and an authorization class being assigned to the user by means of a user database, access request data for access to the logical records of the at least one source database being transmitted from the communication device via the network to the central unit, and the personalized, access-controlled data and/or programs being generated by means of a filter module of the central unit based on the authorization class of the user and the access request data. For generating the personalized data the central unit can comprise e.g. a HTML (Hyper Text Markup Language) and/or HDML (Handheld Device Markup Language) and/or WML (Wireless Markup Language) and/or VRML (Virtual Reality Modeling Language) and/or ASP (Active Server Pages) module. This embodiment variant has the advantage, among other things, that the access to same logical records can be controlled and administered divided according to authorization classes. At the same time the access-controlled data and/or programs can be simply adapted and optimized user-specifically.

In an embodiment variant, it is determined by means of the access request data of the user to which user and/or user classes the personalized, access-controlled data and/or programs are transmitted. This embodiment variant has the advantage, among other things, that protected information can be transmitted to a plurality of different users in a simple way (e.g. congress information, etc.) without the instructing party having to pay attention to authorization classes and/or access rights, etc. Access request data can thereby contain only content-oriented data, for example.

In another embodiment variant, the data are filtered according to the authorization class of the respective user by means of an additional filter module of the communication device. This embodiment variant has advantages in particular when the personalized data and/or programs are transmitted via a second unidirectional communication channel, such as e.g. a broadcast transmitter, to a plurality of communications devices at the same time, or in a completely general way when the personalized data and/or programs are supposed to be transmitted to a plurality of users simultaneously. Each user can then filter and/or decrypt the data self-sufficiently according to his authorization class.

In a further embodiment variant, clearing data are transmitted from the central unit to a clearing module, which clearing data contain billing data for said access to the access-controlled, personalized data and/or programs. In particular the authorization classes and/or a user profile can contain, for instance, access conditions data which establish a monetary value for a credit limit definable by the user and/or the central unit, up to which credit limit an automatic billing takes place of the personalized data and/or programs obtained. This has the advantage, among other things, that in paying for the access to the personalized data and/or programs the user or the central unit can determine freely which type of billing is supposed to be carried out up to which amounts. Furthermore in a completely general way this embodiment variant has the advantage that obtained data can be billed to the user automatically.

In a still different embodiment variant, a user profile is created based on the respective user behavior and is stored assigned to the user, the access-controlled, personalized data and/or programs being generated and/or optimized at least partially based on the user profile. The user profile can comprise e.g. personalized data about network features and/or data on hardware characteristics of the communication device of the user and/or data about user behavior. An advantage of this embodiment variant is, among other things, that the user can thereby administrate or have administrated centrally a plurality of completely different communication devices. He can, for example, send the access request to the central unit by means of a WAP and/or SMS-capable mobile radio device, and later, for instance, quickly access the provided personalized data via a more convenient interface of a computer system.

In an embodiment variant, the access-controlled, personalized data and/or programs can be stored, accessible to the user, in a permanent data store of the central unit. This makes sense especially for embodiment variants where the user can define a plurality of user profiles for different communication devices. An advantage of this embodiment variant is that, among other things, the user can thereby administrate centrally a plurality of completely different communication devices. Thus, for example, he can define and administrate for the central unit via a fast interface of a computer system the data to be provided for another communication device, such as a WAP and/or SMS-capable mobile radio device.

In another embodiment variant, different user profiles for different communication devices are stored assigned to the user. This embodiment variant has the advantage, among other things, that e.g. data can be conveniently requested and sent by a user to all participants of a meeting or another event according to their authorization class

In a further embodiment variant, the access request data are transmitted to the central unit via a first bidirectional communication channel, and the access-controlled, personalized data and/or programs are transmitted to the communication device via a second communication channel in an encrypted way and unidirectionally. The first bidirectional communication channel can comprise at least a mobile radio network and/or the second unidirectional communication channel at least a broadcast transmitter. This embodiment variant has the advantage, among other things, that with the first communication channel (security channel) a high degree of security is achieved for the identification of the user and transmission of the access request data. For the data throughput-intensive transmission then a faster, and in some circumstances also cheaper, broadband channel can be selected, the second unidirectional communication channel.

It should be stated here that, besides the method according to the invention, the present invention also relates to a system for carrying out this method. Furthermore it is not limited to said system and method, but likewise relates to a computer program product for achieving the method according to the invention.

Embodiment variants of the present invention will be described in the following with reference to examples. The examples of the embodiments are illustrated by the following attached FIGURE:

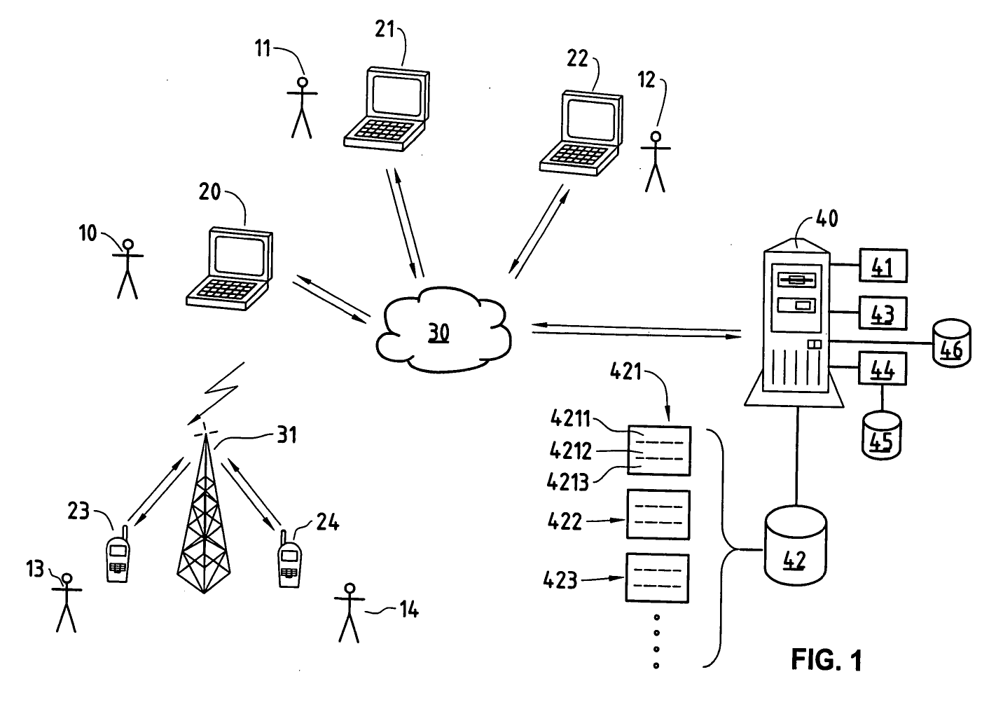

FIG. 1 shows a block diagram reproducing diagrammatically the system or respectively the method for automated generation of access-controlled, personalized data and/or programs. By means of a communication device 20, . . . ,24, a user 10, . . . , 14 accesses a central unit 40 via a network 30/31, and the access-controlled data and/or programs are transmitted to at least one communication device 10, . . . , 14.

FIG. 1 illustrates schematically an architecture which can be used to achieve the invention. In this embodiment example, a user 10, . . . , 14 accesses a central unit 40 via a network 30/31 using a communication device 20, . . . ,24, access-controlled data and/or programs being transmitted to at least one communication device 10, . . . , 14. The network 30/31 can comprise a communication network, such as e.g. a GSM or a UMTS network, or a satellite-based mobile radio network, and/or one or more fixed networks, for example the public switched telephone network, the worldwide Internet or a suitable LAN (Local Area Network) or WAN (Wide Area Network). In particular it also comprises ISDN and XDSL connections. The connection between receiving device 20, . . . ,24 and central unit 40, however, can also take place via different data channels and not just direct via the described communication networks 30/31. The data can be transmitted e.g. between the receiving device 20, . . . ,24 and the central unit 40 via an interface (e.g. a wireless interface, such as an infrared interface or Bluetooth) to a data terminal, and from the data terminal via a communication network, or by means of a removable chipcard of the receiving device 20, . . . ,24, which card is inserted in a data terminal, via this data terminal and a communication network 30/31 to the central unit 40. In the preferred embodiment variant, however, the receiving device 20, . . . ,24 and the central unit 40 each comprise a communications module. By means of the communications module data can be exchanged over the communication network 30/31. As already mentioned, the communication network 30/31 comprises, for example, a mobile radio network, for instance a GSM, GPRS or UMTS network, or another, e.g. satellite-based mobile radio network, or a fixed network, for instance an ISDN network, the public switched telephone network, a TV or radio cable network, or an IP network (Internet Protocol). In particular, in receiving devices 20, . . . ,24 designed as mobile devices the communications module comprises a mobile radio module for communication via a mobile radio network 31 and/or WLAN. Understood by access-controlled data and/or programs are, for example, among other things, digital data such as texts, graphics, pictures, maps, animations, moving pictures, video, QuickTime, sound recordings, programs (software), program-accompanying data and hyperlinks or references to multimedia data. Also belonging thereto are e.g. MPx (MP3) or MPEGx (MPEG4 or 7) standards, as defined by the Moving Picture Experts Group. The communication device 20, . . . ,24 of the user can be, for example, a PC (Personal Computer), TV, PDA (Personal Digital Assistant) or a mobile radio device (in particular e.g. in combination with a broadcast receiver). The logical records 421, . . . ,423 are generated with data elements 4211, . . . ,4214 divided according to authorization classes and are stored in at least one source database 42. For generating the logical records 421, . . . ,423, the data can be stored, accessible to the central unit 40, e.g. in different places in different networks or locally. The last-mentioned networks can comprise e.g. a LAN (Local Area Network) or a WAN (Wide Area Network), the Internet, broadcast cable networks, PSTN, PLMN, among others. The logical records 421, . . . ,423 can be extracted e.g. with reference to a content-based index technique and can comprise key words, synonyms, references to multimedia data (e.g. also hyperlinks), picture and/or sound sequences, etc. Such systems are known in the state of the art in most diverse variations. Examples thereof are the U.S. Pat. No. 5,414,644 describing a three-file indexing technique or the U.S. Pat. No. 5,210,868, which also stores additionally synonyms as search keywords during the indexing of the multimedia data and the extracting of the metadata. In the present embodiment example, the logical records 421, . . . ,423 can also be generated, however, at least in part dynamically (in real time), based on user data of an access request, i.e. not only based on data of the source database 42. This has, for instance, the advantage that the logical records 421, . . . ,423 of the at least one source database 42 always have the up-to-date character and precision expedient for the user. Thus there exists a kind of feedback possibility to the central unit 40 from the user behavior at the communication device 20, . . . ,24 which can directly influence the extraction or respectively the generation of the logical records. 421, . . . ,423. So-called agents can be employed in particular during the search for certain data.

The user 10, . . . , 14 is identified by the central unit 40, an authorization class being assigned to the user 10, . . . , 14 by means of a user database 45. Personal identification numbers (PIN) and/or so-called smart cards can be used for identification, for instance. Smart cards normally presuppose a card reader at the communication device 20, . . . ,24. In both cases the name or another identification of the user 10, . . . , 14 as well as the PIN are transmitted to the central unit 40 or to a trusted remote server. An identification module 44 or respectively authentication module 44 decrypts (if necessary) and checks the PIN via the user database 45. As an embodiment variation, credit cards can also be used for identification of the user 10, . . . , 14. If the user 10, . . . , 14 uses his credit card, he can likewise enter his PIN. The magnetic strip of the credit card typically contains the account number and the encrypted PIN of the authorized owner, i.e. in this case of the user 10, . . . , 14. The decryption can take place directly in the card reader itself, as is common in the state of the art. Smart cards have the advantage that they make possible greater security against fraud through an additional encryption of the PIN. This encryption can take place either through a dynamic coding scheme containing e.g. time, day or month, or another algorithm. The decryption and identification does not take place in the apparatus itself, but externally via the identification module 45. A further possibility is a chipcard inserted directly into the communication device 20, . . . ,24. The chipcard can be, for instance, an SIM card (Subscriber Identification Module) or smart card, a call number being assigned to the chipcards in each case. The assignment can be carried out, for example, via an HLR (Home Location Register), by the IMSI (International Mobile Subscriber Identification), e.g. an MSISDN (Mobile Subscriber ISDN), being stored assigned to a call number in the HRL. An unambiguous identification of the user 10, . . . , 14 is possible then via this assignment.

The user 10, . . . , 14 transmits access request data for access to the logical records 421, . . . ,423 of the at least one source database 42 of the communication device 20, . . . ,24 via the network 30/31 to the central unit 40. The access request data can be entered via input elements of the communication device 20, . . . ,24. The input elements may comprise e.g. keyboards, graphic input elements (mouse, trackball, eye tracker with virtual retinal display (VRD), etc.), but also IVR (Interactive Voice Response) etc. The user 10, . . . ,14 has the possibility of determining by himself at least part of the access request data e.g. on the basis of transmitted content indications of the at least one source database 42 and/or access conditions data. This can take place e.g. in that the user is asked by the receiving device 20, . . . ,24 to give his consent via an interface to access conditions or to part of the access conditions. Conditions of access to the data of the source database 42 can include in particular an additional authentication and/or fees for the access. The access request data are checked in the central unit 40, and the desired personalized, access-controlled data and/or programs are then generated on the basis of the authorization class of the user 10, . . . ,14 and the access request data by means of a filter module 41. The personalized data can be generated and transmitted e.g. in HTML (Hyper Text Markup Language) and/or HDML (Handheld Device Markup Language) and/or WML (Wireless Markup Language) and/or VRML (Virtual Reality Modeling Language) and/or ASD (Active Server Pages). This can be carried out e.g. by means of a corresponding module, achieved through hardware and/or software, of the central unit 40. The advantage of the active server technology is, among other things, that it allows a dynamic access interface and/or access surface to be generated for so-called access on demand. Other technologies with similar advantages are also just as conceivable of course.

By means of the filter module 41, the personalized, access-controlled data and/or programs can also be provided with an electronic stamp, an electronic signature or an electronic watermark. The electronic signature allows the personalized, access-controlled data and/or programs to be assigned at any later point in time to the user 10, . . . , 14 who obtained them from the central unit 40. The misuse of personalized, access-controlled data and/or programs, subject to fees, by the user 10, . . . , 14 can thereby be prevented. By means of an additional filter module of the communication device 20, . . . ,24, the data of the respective user 10, . . . , 14 can be first filtered in the communication device 20, . . . ,24, e.g. also according to the authorization class. For example, the central unit 40 can generate a data token and transmit it to the receiving device 20, . . . ,24, a data token comprising in each case data for a corresponding key to the encrypted, access-controlled programs and/or data or an access permit for a key for decrypting access-controlled programs and/or data. The various data elements 4211, . . . ,4214 of the logical records 421, . . . ,423 can thereby not only be divided according to authorization classes, for example, but be encrypted by means of different keys. Additional security can thereby be attained ensuring that a user 20, . . . ,24 can really only decrypt just the data elements 4211, . . . ,4214 to which he is entitled according to his authorization class. This embodiment variant has advantages in particular when the personalized data and/or programs are transmitted to a multiplicity of communication devices 20, . . . ,24 at the same time, for instance via a second unidirectional communication channel, such as e.g. a broadcast transmitter.

As described, the access-controlled data and/or programs are transmitted from the central unit 40 to at least one communication device 10, . . . , 14. The data can be transmitted automatically (e.g. after placing the access request), for instance as a data stream in a push-down method or with corresponding transfer protocols, etc., from the central unit 40 to the communication device 10, . . . , 14. The access-controlled, personalized data and/or programs can also be stored first in a permanent data store 46, accessible to the user 10, . . . , 14, of the central unit 40, for instance, so that the user can access the data at any later point in time using the communication device 10, . . . , 14. As an embodiment variant, clearing data can be additionally transmitted in this embodiment example from the central unit 40 to a clearing module 43, which clearing data contain billing data for said access to the access-controlled, personalized data and/or programs. The clearing data can comprise billing records (e.g. electronically signed), similar to CDR records (Call Data Records), as so-called DUR records (DAB/DVB Usage Records), which are transmitted via the central unit 40 to the clearing module 43. It should likewise be mentioned that the clearing module 43 does not necessarily have to be integrated into the central unit 40, but instead can, as an independent unit, be connected to the central unit 40 via a communication network 30/31. If the clearing data contain billing data with billing parameters for debiting or crediting monetary values to the user and/or provider according to the obtained access-controlled programs and/or data, the costs for the access are calculated by the central unit 40, and the clearing of the monetary values via the monetary institution is credited to a corresponding account (thus, in the case of the user, sponsoring is also possible, for instance) or debited. This can also take place before, after or at predetermined intervals (e.g. periodically) during the user's access to the access-controlled data. During the billing of said access by the central unit 40, the debiting and/or crediting can also have the monetary value of 0. The user can also receive crediting of other monetary values or other services, however, e.g. through the viewing of an advertising segment integrated into the transmitted data. By means of the mentioned communications module, in particular the clearing data can be transmitted to the central unit 40 or from the central unit 40 to the communication device 20, . . . ,24, for example periodically (e.g. with GSM/SMS, GSM/USSD, GPRS or UMTS) or in each case after reaching a defined value for the monetary amount or a defined time frame. Upon reaching a predefined value, the solvency of the respective user 10, . . . , 14 can also be checked by the central unit 40 with a financial institution, for instance. The predefined value of the monetary amount can be stored e.g. in a data store of the receiving device 20, . . . ,24. The crediting or respectively debiting can take place before or after (prepaid/postpaid) reaching the monetary value. Thus in the latter variant, the stored monetary value corresponds to a credit limit which is set e.g. by the central unit 40 or respectively by the clearing module 43, depending upon the option. The calculation of the costs and their comparison with a predefined monetary value can be carried out by a cost capturing module of the receiving device 20, . . . ,24. This module calculates the costs for the access to the access-controlled programs and/or data based on the cost data transmitted from the central unit 40. The cost capturing module is, for example, a programmed software module, which is implemented on a processor of the receiving device 40 or a chipcard, or a module achieved through hardware. In the embodiment variant with the chipcard, the chipcard can be e.g. a multifunctional SIM card taking into account the MexE specifications (Mobile Station Application Execution Environment).

Based on the respective user behavior, the central unit 40 can create a user profile and store it assigned to the user 10, . . . , 14, the access-controlled, personalized data and/or programs being generated and/or optimized based at least partially on the user profile. Stored in the user profile can be e.g. user-specific data about network features and/or data on hardware characteristics of the communication device of the user 10, . . . , 14 and/or data about user behavior. In particular, different user profiles, e.g. for different communication devices 20, . . . ,24, can also be stored assigned to a user 10, . . . , 14. As mentioned, said user profiles can be created e.g. automatically by means of the central unit 40 based on the respective user behavior and/or based on user information from the user 10, . . . , 14, and can be stored, assigned to the user, in the central unit 40. Using the data of the at least one source database 42, the central unit 40 can generate data and/or programs, optimized user-specifically based on the user profile. The user profile remains stored in the central unit 40, e.g. permanently assigned to a particular user, or e.g. is newly created with each access request. The user profile can also comprise in particular further processing conditions data, which are definable by the user 10, . . . , 14 and/or the central unit 40 and/or authorized third parties (such as e.g. the providers of multimedia data subject to fees and/or protected by copyright, etc.).

In the embodiment example, the communication between the central unit 40 and the communication device 20, . . . ,24 can also take place, for instance, via a plurality of communication channels, instead of via a bidirectional communication channel. Thus, for example, the access request data can be transmitted over a first bidirectional communication channel (e.g. protected channel/security channel) to the central unit 40, whereby the user 10, . . . , 14 is identified. In a second step, the access-controlled, personalized data and/or programs are encrypted and are transmitted unidirectionally over a second communication channel (broadband channel) to the communication device 20, . . . ,24. The first bidirectional communication channel can comprise, for instance, at least a mobile radio network 31. On the other hand, the second unidirectional communication channel can comprise at least a broadcast transmitter, for instance. The broadcast transmitter transmits the programs and/or data unidirectionally to receiving devices 20, . . . ,24, for instance by means of radio waves from a terrestrial or satellite-based broadcast transmitting antenna over an air interface, or via broadcast cable networks. The operator of the central unit 40 can likewise include the various aspects in their well established differentiation, such as the broadcast content provider (responsible for the broadcast program), the broadcast service provider (packaging etc.) and the broadcast network provider (broadcasting, responsible for the conditional access etc.). For this embodiment variant, the receiving device 20, . . . ,24 is equipped with a broadcast receiver, by means of which the programs and/or data broadcast by the broadcast transmitter can be received via broadcast channels, for instance via the broadcast cable network or as radio waves by means of a receiving antenna via an air interface. Broadcast systems with such broadcast transmitters and broadcast receivers are known, for instance, under the designation Digital Audio Broadcasting (DAB), or respectively Digital Video Broadcasting (DVB). In order to limit access to individual services or a plurality of services or to service components of the central unit 40 (in connection with DAB these services and service components are audio programs and/or data(-services), in connection with DVB video or respectively television programs and/or data(-services)) for authorized users, mechanisms are defined in the ETSI standard for access-controlled programs and/or data(-services), the so-called conditional access. Described in particular in the aforementioned ETSI standards are scrambling/descrambling procedures (encryption/decryption), parameters for signalling and synchronization of the conditional access as well as mechanisms for control and distribution of authorizations (authorization data for users) through the transmission of so-called ECM messages (Entitlement Checking Messages) and EMM messages (Entitlement Management Messages) over the broadcast channels (broadcast cable network or air interface). Thus a conditional access flag and/or a conditional access identifier can be used for each of the service components transmitted over broadcast channels in order to indicate to the broadcast receiver whether the respective service component uses conditional access mechanisms or not, and if so, which type of mechanisms is used. For services components which are in a controlled access mode and which are designated in this text as access-controlled programs and/or data, the data of the respective service components (which can relate to programs and/or data) are encrypted with a control word, this control word being changed regularly and being, for its part, transmitted in the ECM messages to the broadcast receiver encrypted by means of a session key (key). By means of the conditional access identifier, a so-called access control system of the receiving device 20, . . . ,24 is identified, which access control system can interpret and process the ECM and EMM messages transmitted by the broadcast transmitter. In the present embodiment example, for access to the access-controlled programs and/or data by a user 10, . . . , 14 of the receiving device 20, . . . ,24, the access-controlled programs and/or data broadcast in an encrypted way can be decrypted in the receiving device 20, . . . ,24, if access conditions data received via the broadcast channel for the access-controlled programs and/or data corresponds with authorization data of the user. For example, cost data can also be transmitted by the broadcast transmitter to the receiving device 20, . . . ,24 in the ECM messages, i.e. program costs for the access-controlled programs and/or data, which are available for spontaneous payment per service, and/or costs per time unit or calculation unit for the access-controlled programs and/or data, which are available for spontaneous payment per time unit or calculation unit and per service. A calculation unit can be, for instance, a time unit, a logical unit, such as e.g. an entire video film or an entire music piece etc., or a transmitted quantity of data. Besides costs, the received access conditions data can also comprise, however, any other access conditions for access to the access-controlled programs and/or data. The unencrypted programs, or respectively data, can be reproduced, for example, for the user 10, . . . , 14 of the receiving device 20, . . . ,24 via a processing module of the receiving device 20, . . . ,24 and from there via electro-acoustical converters, or respectively display units.

It is important to point out that, as an embodiment variant, by means of the access request data, the user 10, . . . , 14 can determine to which users 10, . . . , 14 and/or user classes the personalized, access-controlled data and/or programs are supposed to be transmitted. The user 10, . . . , 14, to whom the data are transmitted does not thereby necessarily have to be the same as the user 10, . . . , 14, who has transmitted the access request data to the central unit 40. Based on the authorization class of a user 10, . . . , 14, certain user groups can also be blocked by the central unit 40 from transmitting personalized, access-controlled data and/or programs. With this embodiment variant, for example, data can be sent conveniently by a user 10, . . . , 14 to all participants in a meeting or another event according to their authorization class.

1. A method of automated generation and of making available of access-controlled, personalized data and/or programs, a user accessing a central unit via a network by means of a communication device and the access-controlled, personalized data and/or programs being transmitted to at least one communication device, wherein
logical records are generated having data elements divided according to authorization classes and are stored in at least one source database,
the user is identified by the central unit, an authorization class being assigned to the user by means of a user database,
access request data for access to the logical records of the at least one source database are transmitted from the communication device via the network to the central unit,
the access-controlled, personalized data and/or programs are generated by means of a filter module of the central unit based on the authorization class of the user and on the access request data, and are made available to the user in an accessible way.

2. The method according to claim 1, wherein determined by means of the access request data of the user is to which user and/or user groups the personalized, access-control data and/or programs are transmitted.

3. The method according to claim 1, wherein the data are filtered according to the authorization class of the respective user by means of an additional filter module of the communication device.

4. The method according to claim 1, wherein clearing data are transmitted from the central unit to a clearing module, which clearing data contain billing data for said access to the access-controlled, personalized data and/or programs.

5. The method according to claim 1, wherein a user profile is created based on the respective user behavior and is stored assigned to the user, the access-controlled, personalized data and/or programs being generated and/or optimized at least partially based on the user profile.

6. The method according to claim 1, wherein the access-controlled, personalized data and/or programs are stored in a permanent data store of the central unit accessible to the user.

7. The method according to claim 1, wherein stored in the user profile are user-specific data about network features and/or data about hardware characteristics of the communication device of the user and/or data about user behavior.

8. The method according to claim 1, wherein different user profiles for different communication devices (20, . . . ,24) are stored assigned to the user.

9. The method according to claim 1, wherein the access request data are transmitted to the central unit over a first bidirectional communication channel, the user being identified, and the access-controlled, personalized data and/or programs are transmitted to the communication device in an encrypted manner and unidirectionally over a second communication channel.

10. The method according to claim 9, wherein the first bidirectional communication channel comprises at least a mobile radio network and/or the second unidirectional communication channel comprises at least a broadcast transmitter.

11. The method according to claim 1, wherein HTML and/or HDML and/or WML and/or VRML and/or ASD are used for generating the personalized data.

12. A system for automated generation and for making available of access-controlled, personalized data and/or programs, which system comprises a central unit, at least one source database and a plurality of communication devices, the access-controlled, personalized data and/or programs being transmittable by means of a network from the central unit to the communication devices, wherein
the at least one source database contains logical records having data elements divided according to authorization classes,
the system comprises an identification module with a user database, in which an authorization class is stored assigned to each user,
the central unit comprises a filter module, by means of which the access-controlled, personalized data and/or programs are able to be generated based on the authorization class of a user and based on access request data transmitted by means of the user unit, and are able to be made available to the user in an accessible way.

13. The system according to claim 12, wherein the access request data of the user contain destination data with which it is definable to which user and/or user classes the access-controlled, personalized data and/or programs are to be transmitted.

14. The system according to claim 12, wherein the communication device further comprises a filter module to filter the data according to the authorization class of the respective user.

15. The system according to claim 12, wherein the central unit comprises a clearing module for generating clearing data, which clearing data contain billing data for said access to the access-controlled, personalized data and/or programs.

16. The system according to claim 12, wherein the central unit contains a user profile stored assigned to the user, the access-controlled, personalized data and/or programs being generated and/or optimized at least partially based on the user profile.

17. The system according to claim 12, wherein the central unit comprises a permanent data store, in which the access-controlled, personalized data and/or programs are stored in a way accessible to the user.

18. The system according to claim 12, wherein the user profile comprises user-specific data about network features and/or data about hardware characteristics of the communication device of the user and/or data about user behavior.

19. The system according to claim 12, wherein the central unit comprises different user profiles for different communication devices of the user.

20. The system according to claim 12, wherein the system comprises a first bidirectional communication channel for transmitting the access request data to the central unit and a second communication channel, the user being identifiable via the first bidirectional communication channel, and the access-controlled, personalized data and/or programs are transmittable to the communication device in an encrypted manner and unidirectionally over the second communication channel.

21. The system according to claim 20, wherein the first bidirectional communication channel comprises at least a mobile radio network and/or the second unidirectional communication channel comprises at least a broadcast transmitter.

22. The system according to claim 12, wherein the system comprises a data module for generating personalized data in HTML and/or HDML and/or WML and/or VRML and/or ASD format.
